(19) United States
(12) Patent Application Publication
(10) Pub. No.: US 2025/0292065 A1
(43) Pub. Date: Sep. 18, 2025

(54) GRAPH-BASED ENTITY RESOLUTION FRAMEWORK USING VARIATIONAL INFERENCE

(71) Applicant: Oracle International Corporation, Redwood Shores, CA (US)

(72) Inventors: Soomin Lee, Zürich (CH); Filip Carevic, Ecublens (CH); Marcel Gwerder, Dietikon (CH)

(21) Appl. No.: 18/902,110

(22) Filed: Sep. 30, 2024

Related U.S. Application Data
(60) Provisional application No. 63/565,086, filed on Mar. 14, 2024.

(51) Int. Cl. G06N 3/045; G06N 3/0895

(52) U.S. Cl. CPC G06N 3/045; G06N 3/0895

(57) ABSTRACT

The present disclosure relates to entity resolution between graphs of entities and their relations. A language model (LM) and a graph neural network (GNN) may be iteratively trained. A plurality of first node embeddings for a plurality of nodes in a graph may be generated using the LM. A plurality of second node embeddings for the plurality of nodes based at least in part on the plurality of first node embeddings and the graph may be generated using the GNN. A first node and a second node of the plurality of nodes that both represent a particular entity may be identified based at least in part on a similarity between one of the plurality of second node embeddings associated with the first node and one of the plurality of second node embeddings associated with the second node

### RELATED APPLICATION DATA AND CLAIM OF PRIORITY

This application claims the benefit of U.S. Provisional Application No. 63/565,086 entitled “Graph-based Entity Resolution Framework Using Variational Inference”, filed Mar. 14, 2024, the contents of which are incorporated by reference for all purposes as if fully set forth herein.

### TECHNICAL FIELD

The present disclosure relates to graph-based entity resolution.

### BACKGROUND

Having complete and centralized data is a crucial part of business intelligence (BI) pipelines and decision-making processes. Obtaining such data includes collecting records from the heterogeneous sources and merging them into single, unified views of the objects they describe. For example, in the financial domain, records about customers are scattered across various customer databases and external providers, while their unification improves risk assessment and customer relationships management.

With the increase of the amount of data being generated, though, companies contend with multiple data streams of varying quality. The disparity between different data streams can provide a misleading or fragmented view of the real world. Thus, data often needs to be consolidated and disentangled to gain actionable insights and make decisions based on the data.

Entity resolution is the process of identifying and linking records that describe the same real-world objects. Entity resolution may resolve disparate sets of data that, in fact, refer to a single real-world entity into a unique entity profiles. Generalizing this process to graph-structured data has been the topic of interest for both database and machine learning communities. A two-step approach has emerged for graph-based entity resolution, where, in the first step, language models are leveraged to encode semantic information from attributes, and in the second step, specialized model architectures are employed to capture relationships from the graph structure. But these approaches either train graph encoders using out-of-the-box language models as feature generators or use supervised contrastive methods to initially improve language models. Note that in the latter case, only graph encoders benefit from the improved language models.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

### In the Drawings:

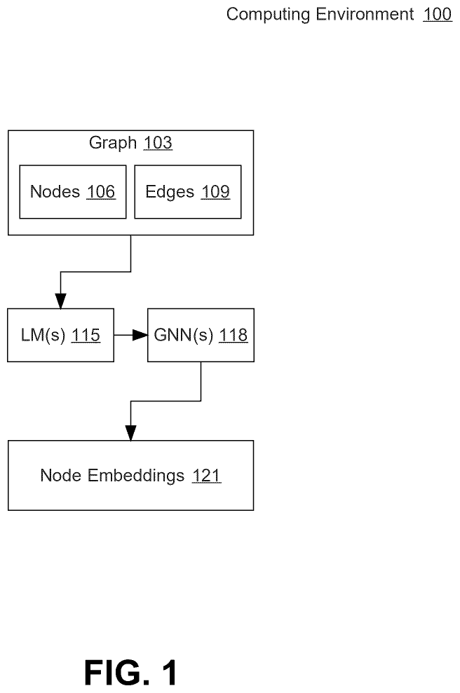

FIG. 1 illustrates a block diagram depicting an example of a computing environment according to various embodiments of the present disclosure.

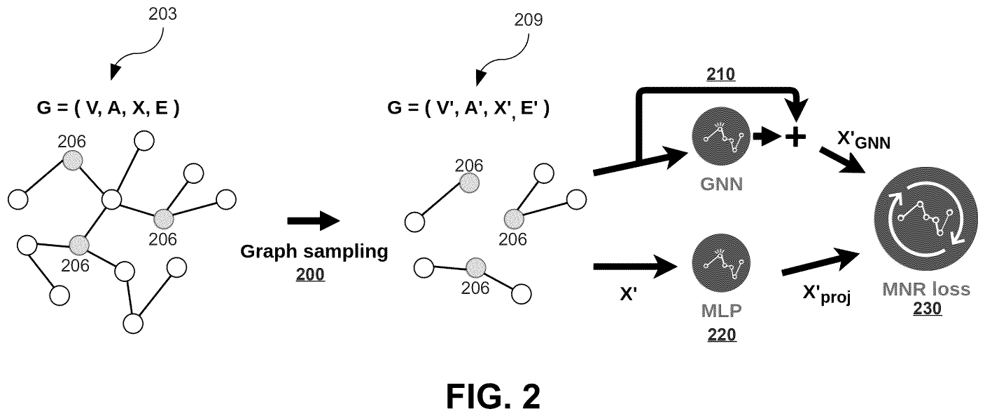

FIG. 2 illustrates an example of a unsupervised self-explanation (SE) training procedure for a graph neural network, according to various embodiments of the present disclosure.

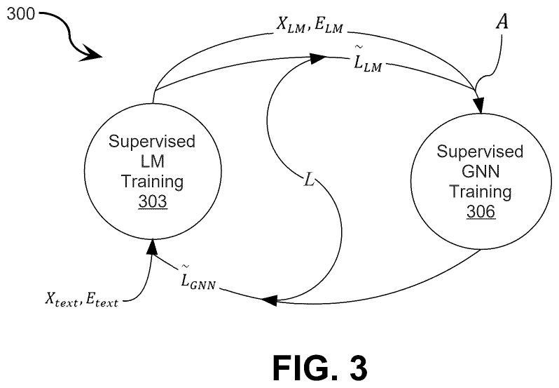

FIG. 3 illustrates an example of a supervised variational inference training procedure, according to various embodiments of the present disclosure.

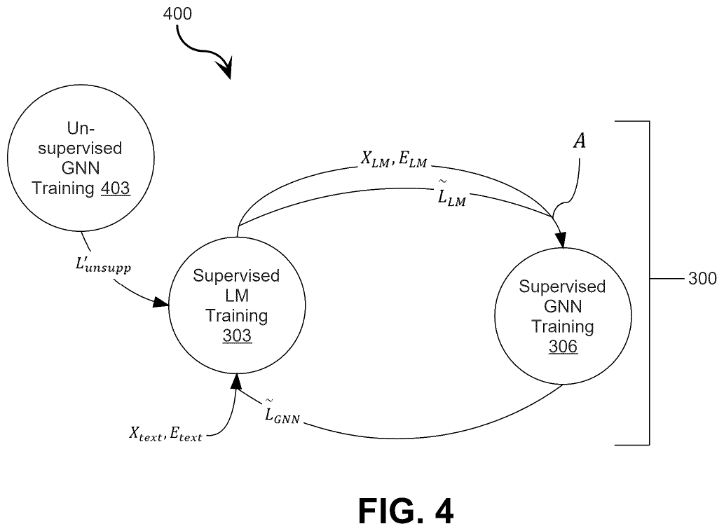

FIG. 4 illustrates an example of an unsupervised variational inference training procedure, according to various embodiments of the present disclosure.

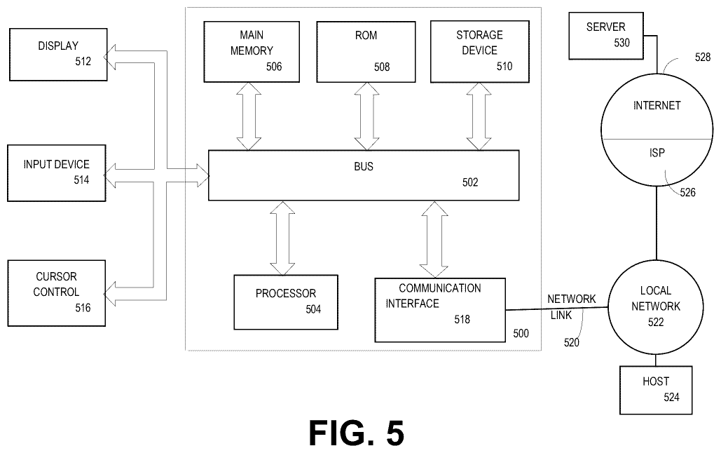

FIG. 5 is a block diagram that illustrates a computer system upon which an embodiment of the invention may be implemented.

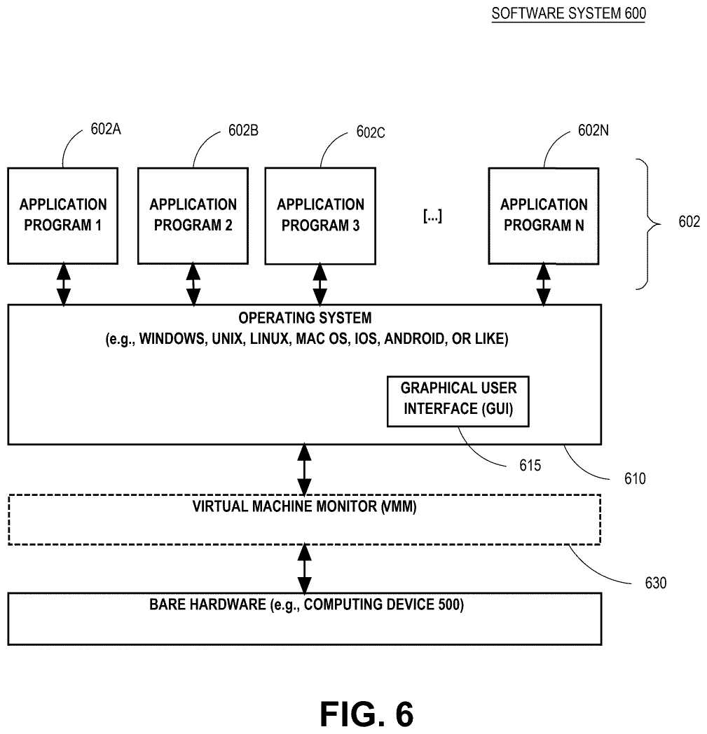

FIG. 6 is a block diagram of a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### 1. General Overview

The present disclosure relates to entity resolution between graphs of entities and their relations. To take both the attributes for entities and their relationship information, the disclosed approaches may use a language model (LM) and a graph neural network (GNN). The LM may be used for textually-represented attributes of the nodes and edges of the graph, while the GNN may be used for the graph itself. These models may be jointly trained using an adjusted variational inference methodology to provide a scalable training methodology.

Given a graph where nodes represent entities and edges represent relations between entities, the disclosed approaches infer which nodes in the graph refer to the same real-world object. Two nodes may refer to the same real-world object if they have similar attributes and similar neighborhoods. The disclosed approaches create vector representations of nodes that encode attribute and k-hop neighborhood information for each node and perform similarity search with the nodes in the vector domain.

The disclosed approaches use supervised and unsupervised methods for graph-based entity resolution that aim to mutually improve models from both steps. In the supervised method, language models may benefit from the enhanced structural understanding of graph encoders, while graph encoders may benefit from the improved features given by the refined language models. This results in a synergistic improvement loop between the two sets of models. The unsupervised method adapts the supervised method to environments without annotated data.

The disclosed approaches use text-attributed graphs that may represent attributes of the nodes and edges of the graph in textual form. Given a text-attributed graph Gₜₑₓₜ=(V, A, Xₜₑₓₜ, Eₜₑₓₜ), V is the set of nodes, E is the set of edges, and Xₜₑₓₜ and Eₜₑₓₜ denote corresponding node and edge attributes, respectively. If the domain of all such graphs Gₜₑₓₜ is defined as [symbol] , the disclosed approaches include learning an encoding function ζ: [symbol] → [symbol] ^{N×D} that, for an arbitrary graph G′ₜₑₓₜ∈ [symbol] returns the vector representations X=[x₁, x₂, . . . , x_{N}]^{T} of its nodes, where each of xᵢ as a D-dimensional vector. Nodes that refer to the same objects are presumed to have similar representations. Thus, the disclosed approaches include finding the encoder function ζ that for all such nodes produces similar vectors, while producing dissimilar vectors otherwise. The vector similarity metric may be defined as, for example, cosine similarity.

### 2. System Overview

FIG. 1 illustrates a block diagram depicting an example of a computing environment 100 according to various embodiments of the present disclosure. The computing environment 100 may include a computing device, such as a server computer, that provides computing capabilities. Alternatively, the computing environment 100 may employ multiple computing devices that are arranged in one or more server banks or computer banks. In one example, the computing devices may be located in a single installation. In another example, the computing devices for the computing environment 100 may be distributed among multiple different geographical locations. In one case, the computing environment 100 may include multiple computing devices that together may form a hosted computing resource or a grid computing resource. In addition, the computing environment 100 may operate as an elastic computing resource where the allotted capacity of computing-related resources, such as processing resources, network resources, and storage resources, may vary over time. In other examples, the computing environment 100 may include or be operated as one or more virtualized computer instances that may be executed to perform the functionality that is described herein.

The computing environment 100 includes a graph 103 comprising one or more nodes 106 and one or more edges 109. The nodes 106 may represent entities, while the edges 109 may represent relations between those entities. The graph 103 may be a text-attributed graph Gₜₑₓₜ=(V, A, Xₜₑₓₜ, Eₜₑₓₜ), where V represents the set of nodes 106, A∈{0,1}^{|V|×|V|} represents an adjacency matrix, Xₜₑₓₜ represents attributes of the nodes 106, and Eₜₑₓₜ represents attributes of the edges 109. The graph 103 is a text-attributed graph if the attributes of the nodes 106 xᵢ ∈ Xₜₑₓₜ and the attributes of the edges 109 eᵢ ∈ Eₜₑₓₜ are represented in textual form.

The language model(s) (LM(s)) 115 may be used to embed textual attributes of the nodes 106 and edges 109 of the graph 103 to create their vector representations. Formally, if [symbol] denotes the domain of all textual sequences (i.e., sentences), a language model 115 may be defined as a function ƒ_{ω}: [symbol] → [symbol] ^{D}, where for arbitrary sentence s∈ [symbol] , output of the function ƒ_{ω} is its D-dimensional vector representation νₛ=ƒ_{ω}(s). The language models 115 may convert the text-attributed graph 103, Gₜₑₓₜ=(V, A, Xₜₑₓₜ, Eₜₑₓₜ) to a representation more suitable for the GNNs 118, G=(V, A, X, E), where X ∈ [symbol] ^{|V|×D} and E ∈ [symbol] ^{|V|×|V|×D′}.

The graph neural network(s) (GNN(s)) 118 may be used to extract information from structured data of the graph 103. The GNNs 118 may be designed to operate on representations of the graph 103, G=(V, A, X, E), where V represents the set of nodes 106, A ∈{0,1}^{|V|×|V|} is an adjacency matrix, X∈ [symbol] ^{|V|×D} is a feature matrix for the nodes 103, and E∈ [symbol] ^{|V|×|V|×D′} is a feature matrix for the edges 106. Each row of the matrix X∈ [symbol] ^{|V|×D} may represent a feature vector xᵢ∈ [symbol] ^{D} of node i∈V. The edge feature matrix E may be optional.

The node embeddings 121 may represent output of an inference procedure using the LM 115 and GNN 118. The node embeddings 121 may encode text data representing attributes of the nodes 106, as well as information regarding the k-hop neighborhood of each node 106 in the graph 103. Initial embeddings for the nodes 106 and edges 109 may be generated by the LM 115. The GNN 118 may then generate the node embeddings 121 by enriching the initial node embeddings with k-hop neighborhood information, representing structural information from the graph 103. A similarity search may be performed using the node embeddings 121 to determine which sets of nodes 106 are similar. Nodes 106 with a similarity in their node embeddings 121 that meets or exceeds a predefined threshold may be determined to refer to a same entity.

### 3. Training Algorithms

The disclosed approaches include supervised training procedures for the LM 115 and GNN 118, as well as an unsupervised “self-explanation” training algorithm for the GNN 118. These learning methods follow the contrastive learning paradigm and aim to optimize multiple negatives ranking loss. The training objective of graph contrastive learning is to maximize the similarity between positive samples and minimize the similarity between negative samples. Thus, the training objectives of the training procedures discussed below may be to maximize the similarity of pairs of node embeddings 121 that represent the same real world entities and minimize the similarity of pairs of node embeddings 121 that do not represent the same real world entities.

### 3.1. Multiple Negatives Ranking Loss

Multiple negatives ranking (MNR) loss may be used as the objective function in contrastive learning to increase the scores of positive pairs and decrease the scores of negative ones.

Given a vector scoring function S: [symbol] ^{D}× [symbol] ^{D}→ [symbol] and a tuple X=(x, x⁺, x₁⁻, x₂⁻, . . . , x_{N-1}⁻) of N+1 vector samples, where x∈ [symbol] ^{D} is an anchor, x⁺ ∈ [symbol] ^{D} is positive, and xᵢ⁻ ∈ [symbol] ^{D} for ∀i ∈{1, . . . , N−1} are negative samples, MNR loss may be defined as:

$${ℒ}_{S} ( X ) = - log ( \frac{{e}^{S ( x , {x}^{+} )}}{{e}^{S ( x , {x}^{+} )} + \sum {e}^{S ( x , {x}_{i}^{-} )}} )$$

MNR loss may be used in combination with in-batch negative sampling. In particular, given a batch of positive pairs B={(x₁, x₁⁺), (x₂, x₂⁺), . . . , (x_{|B|}, x_{|B|}⁺)}, for each sample xᵢ, |B|−1 negative samples may be defined as Xᵢ⁻={xⱼ⁺|i≠j} (i.e., positive samples from every other pair). MNR loss with in-batch negative sampling may therefore be formulated as:

$${ℒ}_{S} ( B ) = - \frac{1}{\vert B \vert} {\sum }_{∖ i ∈ \{ 1 , … , \vert B \vert \}} log ( \frac{{e}^{S ( {x}_{i} , {x}_{i}^{+} )}}{{e}^{S ( {x}_{i} , {x}_{i}^{+} )} + {\sum }_{j ∈ \{ 1 , … , ) j \neq i} {e}^{S ( {x}_{i} , {x}_{j}^{+} )}} )$$

### 3.2. Language Model Training

Given a vector scoring function S: [symbol] ^{D}× [symbol] ^{D}→ [symbol] , a language model ƒ_{ω} such as the LM 115, and a set of positive pairs Lₜₑₓₜ={(s₁, s₁⁺), . . . , (s_{|L}_{ₜₑₓₜ}_{|}⁺)}, where the samples are represented in textual form, the LM training objective may be defined as:

$${X}_{p a i r s} = \{ ( {f}_{ω} ( {s}_{i} ) , {f}_{ω} ( {s}_{i}^{+} ) ) \vert ( {s}_{i} , {s}_{i}^{+} ) ∈ {L}_{text} \}$$

$${ω}^{*} = {arg min}_{ω} {ℒ}_{S} ( {X}_{pair s} )$$

where [symbol] is the MNR loss with in-batch negative sampling.

The LM 115 may convert textual representations of the nodes 106 and the edges 109 into vectors. Thus, this training procedure may find such language model ƒ_{ω*} that, for the textual representations of positive pairs, produces vector representations that maximize the given scoring function S.

### 3.3. Supervised GNN Training

Given a vector storing function S: [symbol] ^{D}× [symbol] ^{D}→ [symbol] , a GNN model g_{θ}, a graph G=(V, A, X) (which may be a representation of the graph 103) with node 106 feature matrix X∈ [symbol] ^{|V|×D} and adjacency matrix A∈{0,1}^{|V|×|V|}, and a set of positive pairs L⊂V×V, the training objective for the GNN 118 may be defined as:

$${X}^{*} = {g}_{θ} ( G )$$

$${X}_{p a i r s}^{*} = \{ ( {x}_{i}^{*} , {x}_{j}^{*} ) \vert ( i , j ) ∈ L \}$$

$${θ}^{*} = {arg min}_{θ} {ℒ}_{S} ( {X}_{p a i r s}^{*} )$$

where [symbol] is the MNR loss with in-batch negative sampling.

The GNN 118 may create representations of the nodes 106 that reflect structural information of the graph 103. Thus, this training procedure aims to find such GNN model g_{θ}* that, for positive pairs of nodes 106, captures similar patterns in their local graph structures and produces node embeddings 121 that maximize the given scoring function S.

### 3.4. Unsupervised Self-Explanation GNN Training

FIG. 2 illustrates an example of the unsupervised self-explanation (SE) training procedure for the GNN 118. Unsupervised GNN training may use any suitable graph representation learning solution, such as, for example, deep graph infomax (DGI), graph contrastive representation learning (GRACE), or graph contrastive learning with adaptive augmentation (GCA). This training procedure is referred to as “self-explanation” because every node 106 (representation) should be explainable by its neighborhood. In each training iteration, the following steps may be performed.

Step 200 includes graph sampling. Given a graph 203 G=(V, A, X_{LM}, E_{LM}) (such as graph 103) batch_{size} ∈N and k∈N, batch_size nodes (referred to as the root nodes 206, which may be from the nodes 106) may be sampled from G. As a result, a subgraph 209 \tilde{G}=(\tilde{V}, Ã, \tilde{X}_{LM}, \tilde{E}_{LM}) may be constructed by extracting the k-hop neighborhood for each root node 206 and randomly and uniformly removing edges (such as edges 109) with some probability p∈[0,1]. FIG. 2 depicts an example of a scenario where batch_size is set to 3 and direct neighbors are extracted (i.e., k=1). X_{LM} and E_{LM} are embeddings generated by the LM 118 of the nodes 106 and edges 109 of the graph 103, respectively, while \tilde{X}_{LM} and \tilde{E}_{LM} are embeddings of the nodes and edges of the subgraph 209.

Step 210 includes a GNN forward pass. Subgraph \tilde{G} 209 may be passed through a GNN model, such as the GNN 118, with skip connection to obtain the node representations \tilde{X}_{GNN}. The node representations \tilde{X}_{GNN} include embeddings of the nodes in the subgraph 209.

Step 220 includes vector projection. X_{LM}^{proj} may be generated by projecting \tilde{X}_{LM} using a multi-layer perceptron (MLP).

Step 230 includes similarity maximization. The training objective may aim to maximize the similarity between corresponding representations of root nodes 206 from \tilde{X}_{LM}^{proj} and \tilde{X}_{GNN}. For example, MNR loss with in-batch negative sampling may be employed. The scoring function may be, for example, cosine similarity.

Graph sampling may introduce noise to the graph structure and thereby improve the generalizability of models. And because every node 106 is explainable by its neighborhood, \tilde{X}_{LM}^{proj} may denote nodes, \tilde{X}_{GNN} may denote their neighborhoods, and similarity maximization may reflect the explanation term.

### 4. Supervised Variational Inference

In supervised variational interference (SVI), the encoder function ζ may be defined as the composition of a language model fa such as the LM 115 and a graph neural network g_{θ} such as the GNN 118. The LM 115 may be used to encode textual features and create initial node embeddings (and potentially edge embeddings). The GNN 118 may be used to enrich those embeddings with structural information of the graph 103 to generate node embeddings 121. The node embeddings 121 encode information regarding the attributes of the nodes 106 (from the LM 115) and k-hop neighborhood information (from the GNN 118).

The SVI approach assumes that, in addition to a text-attributed graph Gₜₑₓₜ=(V, A, Xₜₑₓₜ, Eₜₑₓₜ), pairs L⊂V×V of nodes are given that represent the same real-world objects. A subset of L may be referred to as the set of ground-truth matches (i.e., every pair is called a match), or labels.

### 4.1. Pseudo-Label Generation

The SVI training procedure may include the generation of pseudo-labels. A pseudo-label may be generated as the union of a ground truth match and a match predicted by the LM 115 or the GNN 118. Vector node representations, or embeddings, may be created as outputs of the LM 115 or the GNN 118. For every node i, a candidate may be generated as the most similar node j. The most similar node j may be a node 106 whose vector representation is most similar to the vector representation of node i. Similarity may be measured using vector similarity metrics such as, for example, cosine similarity or Euclidean distance. The pair of nodes (i, j) may be considered as a predicted match if node i is the candidate for node j, and node j is the candidate for node i.

### 4.2. SVI Training Procedure

FIG. 3 illustrates an example of the SVI training procedure 300. The SVI training procedure 300, the LM 115 may benefit from the enhanced structural understanding of the GNN 118, while the GNN 118 may benefit from the improved features given by the refined LM 115, resulting in a synergistic loop. The SVI training procedure 300 is designed as an iterative procedure, where the following steps are performed in each iteration.

The first step 303 includes supervised training of an LM 115. The LM 115 may be trained using textual representations of the nodes 106 Xₜₑₓₜ and pseudo-labels \tilde{L}_{GNN} generated by the GNN 118 obtained in the immediate previous iteration of the SVI training procedure 300. In the first iteration of the SVI training procedure 300, however, GNN 118 predictions yet exist, so the LM 115 may be trained using the partial ground truth matches (labels L) instead of the pseudo-labels.

Training of the LM 115 may include the process described above in section 3.2, and the vector scoring function may be, for example, cosine similarity. LM training may find an LM 115 that produces similar embeddings for textual representations of positive, matching pairs of nodes 106 and/or edges 109 and dissimilar embeddings for negative, non-matching pairs of nodes 106 and/or edges 109.

The second step 306 includes supervised training of a GNN 118. The GNN 118 may be trained using pseudo-labels \tilde{L}_{LM} and the node 106 embeddings X_{LM} (and, in some examples, the edge 109 embeddings E_{LM}) generated by the LM 115 and obtained after the first step 303 of the current iteration of the SVI training procedure 300. In the second step 306, given node 106 embeddings X_{LM}∈ [symbol] ^{|V|×D}, edge 109 embeddings E_{LM}∈ [symbol] ^{|V|×|V|×D} and adjacency matrix A∈{0,1}^{|V|×|V|}, where |V| is the number of nodes 106 and D is the embedding dimensionality, supervised graph contrastive learning with in-batch negative sampling may be performed as in 3.3 above. Cosine similarity may be used as the vector scoring function.

### 4.3. SVI Inference Procedure

Given a graph with textual node attributes such as the graph 103, the SVI inference procedure may initially leverage the LM 115 to embed node 106 and edge 109 textual attributes to generate vector representations. Later, the SVI inference procedure may use the trained GNN 118 to enrich those vector representations with structural information from the observed graph 103. The inference procedure outputs node embeddings 121. The node embeddings 121 may be used to search for similar nodes 106 (and thus similar entities) in the graph 103.

### 5. Unsupervised Variational Inference

Unsupervised variational inference (UVI) may represent an adaption of the SVI approach to environments that lack annotated data. UVI may assume only a text-attributed graph Gₜₑₓₜ=(V, A, Xₜₑₓₜ, Eₜₑₓₜ) such as the graph 103. The UVI approach may leverage the general expertise of pre-trained language models and enrich that knowledge with structural insights from the observed graphs. The efficiency of UVI can therefore be coupled with the quality of the pre-trained language models used.

### 5.1. UVI Training Procedure

FIG. 4 illustrates an example of a UVI training procedure 400. The UVI training procedure 400 represents a combination of unsupervised self-explanation training procedure discussed in section 3.4 above and the SVI training procedure 300. In particular, given the graph 103 Gₜₑₓₜ=(V, A, Xₜₑₓₜ, Eₜₑₓₜ) and a pre-trained LM 118, the UVI training procedure may include the following phases.

The first phase of the UVI training procedure 400 includes a step 403 of unsupervised GNN training. The LM 115 may be leveraged to embed textual node 106 Xₜₑₓₜ and edge 109 Eₜₑₓₜ attributes. The GNN 118 may be trained using the unsupervised self-explanation GNN training procedure discussed in section 3.4 above. The trained GNN 118 may then be used to predict pseudo-labels L′ᵤₙₛᵤₚ⊂V×V.

The second phase of the UVI training procedure 400 includes the SVI training procedure 300. Pseudo-labels may be generated as an LM or GNN prediction. The set of ground-truth matches may be treated as an empty set. In the initial iteration of the SVI training procedure 300, the pseudo-labels L′ᵤₙₛᵤₚ predicted by the unsupervised GNN 118 in the unsupervised GNN training step 403 may be used to train the LM 118.

### 5.2. UVI Inference Procedure

The UVI inference procedure may be the same as the inference procedure for SVI. In particular, the LM 115 may be used to create initial node embeddings (and potentially edge embeddings) from text representations. The GNN 118 may be used to enrich those embeddings with the structural information of the graph 103 to generate the node embeddings 121.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 505, such as a random access memory (RAM) or other dynamic storage device, coupled to bus 502 for storing information and instructions to be executed by processor 504. Main memory 505 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 505. Such instructions may be read into main memory 505 from another storage medium, such as storage device 510. Execution of the sequences of instructions contained in main memory 505 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 505. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 505, from which processor 504 retrieves and executes the instructions. The instructions received by main memory 505 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 525. ISP 525 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 525, local network 522 and communication interface 518.

The received code may be executed by processor 504 as it is received, and/or stored in storage device 510, or other non-volatile storage for later execution.

### 6. Software Overview

FIG. 6 is a block diagram of a basic software system 600 that may be employed for controlling the operation of computing system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computing system 500. Software system 600, which may be stored in system memory (RAM) 505 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 505) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 600 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
performing iterative training of a language model (LM) and a graph neural network (GNN);
generating, using the LM, a plurality of first node embeddings for a plurality of nodes in a graph;
generating, using the GNN, a plurality of second node embeddings for the plurality of nodes based at least in part on the plurality of first node embeddings and the graph; and
identifying a first node and a second node of the plurality of nodes that both represent a particular entity based at least in part on a similarity between one of the plurality of second node embeddings associated with the first node and one of the plurality of second node embeddings associated with the second node;
wherein the method is performed by one or more computing devices.

2. The method of claim 1, further comprising generating, using the LM, one or more edge embeddings, wherein the plurality of second node embeddings are generated further based on the one or more edge embeddings.

3. The method of claim 1, wherein the similarity between the one of the plurality of second node embeddings associated with the first node and the one of the plurality of second node embeddings associated with the second node is based at least in part on a cosine similarity.

4. The method of claim 1, wherein performing iterative training of the LM and the GNN comprises:
performing supervised training of the LM using textual representations of the plurality of nodes and one or more ground truth labels representing matches between one or more pairs of nodes;
generating, using the LM, embeddings of the plurality of nodes and one or more LM pseudo-labels representing matches between one or more pairs of nodes predicted by the LM;
performing supervised training of the GNN using the embeddings of the plurality of nodes and the LM pseudo-labels;
generating, using the GNN, one or more GNN pseudo-labels representing matches between one or more pairs of nodes predicted by the GNN; and
performing supervised training of the LM using the textual representations of the plurality of nodes and the one or more GNN pseudo-labels.

5. The method of claim 4, wherein the one or more the LM pseudo-labels are generated as a union of a ground truth match and a match predicted by the GNN, and the one or more GNN pseudo-labels are generated as a union of the ground truth match and a match predicted by the LM.

6. The method of claim 1, wherein performing iterative training of the LM and the GNN comprises:
generating, using the LM, embeddings for textual attributes of the plurality of nodes and embeddings for textual attributes of a plurality of edges of the graph;
performing unsupervised training of the GNN using the embeddings for the textual attributes of the plurality of nodes and the embeddings for the textual attributes of the plurality of edges;
generating, using the GNN, one or more GNN pseudo-labels representing matches between one or more pairs of nodes predicted by the GNN;
performing supervised training of the LM using textual representations of the plurality of nodes and the one or more GNN pseudo-labels;
generating, using the LM, embeddings of the plurality of nodes and one or more LM pseudo-labels representing matches between one or more pairs of nodes predicted by the LM; and
performing supervised training of the GNN using the embeddings of the plurality of nodes and the LM pseudo-labels.

7. The method of claim 6, wherein performing the unsupervised training of the GNN comprises:
constructing a subgraph of the graph comprising one more root nodes from the plurality of nodes, one or more respective k-hop neighboring nodes of one or more root nodes, and one or more edges associated with the one or more root nodes that are randomly selected from the plurality of edges;
obtaining, using the GNN with a skip connection, GNN embeddings for one or more nodes in the subgraph;
generating projected embeddings by projecting, using a multi-layer perceptron, at least a portion of the GNN embeddings for textual attributes of the plurality of nodes corresponding to the subgraph;
maximizing a similarity between representations of the one or more root nodes from the GNN embeddings and representations of the one or more root nodes from the projected embeddings using multiple negatives ranking (MNR) loss with in-batch negative sampling.

8. The method of claim 1, wherein the LM is trained to, for textual representations of one or more ground truth matches between nodes, generate a plurality of node embeddings that maximize a vector scoring function.

9. The method of claim 1, wherein the GNN is trained to, for one or more ground truth matches between nodes, generate a plurality of node embeddings that maximize a vector scoring function, wherein individual node embeddings of the plurality of node embeddings capture information regarding one or more neighboring nodes of a corresponding node.

10. The method of claim 1, wherein:
individual node embeddings of the plurality of first node embeddings comprise a vector representation of text representing one or more attributes of a node of a plurality of nodes, and
individual node embeddings of the plurality of second node embeddings comprise a vector representation one or more attributes of a node of a plurality of nodes and structural information of the graph.

11. One or more non-transitory storage media storing instructions which, when executed by one or more computing devices, cause:
performing iterative training of a language model (LM) and a graph neural network (GNN);
generating, using the LM, a plurality of first node embeddings for a plurality of nodes in a graph;
generating, using the GNN, a plurality of second node embeddings for the plurality of nodes based at least in part on the plurality of first node embeddings and the graph; and
identifying a first node and a second node of the plurality of nodes that both represent a particular entity based at least in part on a similarity between one of the plurality of second node embeddings associated with the first node and one of the plurality of second node embeddings associated with the second node;
wherein the method is performed by one or more computing devices.

12. The one or more non-transitory storage media of claim 11, wherein the instructions, when executed, further cause generating, using the LM, one or more edge embeddings, wherein the plurality of second node embeddings are generated further based on the one or more edge embeddings.

13. The one or more non-transitory storage media of claim 11, wherein the similarity between the one of the plurality of second node embeddings associated with the first node and the one of the plurality of second node embeddings associated with the second node is based at least in part on a cosine similarity.

14. The one or more non-transitory storage media of claim 11, wherein the instructions causing performing iterative training of the LM and the GNN, when executed, further cause:
performing supervised training of the LM using textual representations of the plurality of nodes and one or more ground truth labels representing matches between one or more pairs of nodes;
generating, using the LM, embeddings of the plurality of nodes and one or more LM pseudo-labels representing matches between one or more pairs of nodes predicted by the LM;
performing supervised training of the GNN using the embeddings of the plurality of nodes and the LM pseudo-labels;
generating, using the GNN, one or more GNN pseudo-labels representing matches between one or more pairs of nodes predicted by the GNN; and
performing supervised training of the LM using the textual representations of the plurality of nodes and the one or more GNN pseudo-labels.

15. The one or more non-transitory storage media of claim 14, wherein the one or more the LM pseudo-labels are generated as a union of a ground truth match and a match predicted by the GNN, and the one or more GNN pseudo-labels are generated as a union of the ground truth match and a match predicted by the LM.

16. The one or more non-transitory storage media of claim 11, wherein the instructions causing performing iterative training of the LM and the GNN, when executed, further cause:
generating, using the LM, embeddings for textual attributes of the plurality of nodes and embeddings for textual attributes of a plurality of edges of the graph;
performing unsupervised training of the GNN using the embeddings for the textual attributes of the plurality of nodes and the embeddings for the textual attributes of the plurality of edges;
generating, using the GNN, one or more GNN pseudo-labels representing matches between one or more pairs of nodes predicted by the GNN;
performing supervised training of the LM using textual representations of the plurality of nodes and the one or more GNN pseudo-labels;
generating, using the LM, embeddings of the plurality of nodes and one or more LM pseudo-labels representing matches between one or more pairs of nodes predicted by the LM; and
performing supervised training of the GNN using the embeddings of the plurality of nodes and the LM pseudo-labels.

17. The one or more non-transitory storage media of claim 16, wherein the instructions causing performing the unsupervised training of the GNN, when executed, further cause:
constructing a subgraph of the graph comprising one more root nodes from the plurality of nodes, one or more respective k-hop neighboring nodes of one or more root nodes, and one or more edges associated with the one or more root nodes that are randomly selected from the plurality of edges;
obtaining, using the GNN with a skip connection, GNN embeddings for one or more nodes in the subgraph;
generating projected embeddings by projecting, using a multi-layer perceptron, at least a portion of the GNN embeddings for textual attributes of the plurality of nodes corresponding to the subgraph;
maximizing a similarity between representations of the one or more root nodes from the GNN embeddings and representations of the one or more root nodes from the projected embeddings using multiple negatives ranking (MNR) loss with in-batch negative sampling.

18. The one or more non-transitory storage media of claim 11, wherein the LM is trained to, for textual representations of one or more ground truth matches between nodes, generate a plurality of node embeddings that maximize a vector scoring function.

19. The one or more non-transitory storage media of claim 11, wherein the GNN is trained to, for one or more ground truth matches between nodes, generate a plurality of node embeddings that maximize a vector scoring function, wherein individual node embeddings of the plurality of node embeddings capture information regarding one or more neighboring nodes of a corresponding node.

20. The one or more non-transitory storage media of claim 11, wherein:
individual node embeddings of the plurality of first node embeddings comprise a vector representation of text representing one or more attributes of a node of a plurality of nodes, and
individual node embeddings of the plurality of second node embeddings comprise a vector representation one or more attributes of a node of a plurality of nodes and structural information of the graph.
